(19) United States
(12) Patent Application Publication
(10) Pub. No.: US 2020/0332130 A1
(43) Pub. Date: Oct. 22, 2020

(54) COMPOSITION AND METHOD FOR THE INHIBITION OF SNOW AND ICE ADHESION

(71) Applicant: John E. Walls, Kentwood, MI (US)

(72) Inventors: John E. Walls, Kentwood, MI (US); Ruth Ann Smith, Zeeland, MI (US)

(21) Appl. No.: 16/848,558

(22) Filed: Apr. 14, 2020

Related U.S. Application Data
(60) Provisional application No. 62/834,621, filed on Apr. 16, 2019.

(51) Int. Cl. C09D 5/00; C09D 129/14; C09D 163/00; C09D 123/20; C09D 155/02; C09D 183/04

(52) U.S. Cl. CPC C09D 5/00; C09D 129/14; C09D 183/04; C09D 123/20; C09D 155/02; C09D 163/00

(57) ABSTRACT

A composition is described, which when applied to a surface, where it is desirable for snow and ice not to adhere, promotes release of snow and ice from the tire tread or surface for improved traction and performance. The composition is comprised of a binder polymer, a high molecular weight silicone oligomer or polymer(s) and a suitable delivery system permitting easy application, fast drying and excellent adhesion

### CLAIM OF PRIORITY

This application claims priority to application Ser. No. 62/834,621 of the same title, filed Apr. 16, 2019.

### TECHNICAL FIELD

The present invention relates to methods and compositions for inhibiting snow and/or ice adhesion and build up on surfaces and enhance traction on snow and ice surfaces.

### BACKGROUND ART

There are various methods for improving traction with ice and snow surfaces on the market. Most are intended for use to get out of an immediate problem but has no longevity for extended performance. Numerous teachings are directed to the composition of the rubber used in the manufacture of the tire. None have been identified as offering a distinctive advantage over convention rubber compositions. There are spray products on the market which work for 20-50 miles before the coating is worn away.

U.S. Pat. No. 4,427,831 teaches the use of an ordinary rubber and a powder of norbornene polymer which hardens at service temperatures on ice and softens at higher temperatures and which does not lose its shape as a powder when heated during curing or shaping, wherein the ordinary rubber is a butadiene rubber, a styrene-butadiene rubber, an isoprene rubber, or a natural rubber.

U.S. Pat. No. 4,918,142 teaches a rubber composition which comprises a rubber component containing a block copolymer consisting essentially of a block A and a block B, obtained by conducting polymerization of an aromatic vinyl compound and a conjugated diene compound in a hydrocarbon solvent in the presence of an organolithium initiator and modifying with a coupling agent, and satisfying the following conditions (A) to (E). The method of operation improves traction through the surface composition but fails to utilize the benefit of the tread groove surface area.

U.S. Pat. No. 5,530,040 teaches the use of a traction composition comprised of a lignin-based phenolic compound, a silicone resin, a rosin and a suitable carrier. The traction composition may be applied to the surfaces of wet or dry vehicle tires to impart anti-slip properties thereto. In accordance with the present invention, the anti-slip properties have increased durability so that the tires have good traction over a longer distance of travel. In that traction comes from the coating on the surface contacting the pavement, the benefit is lost after several miles.

U.S. Pat. No. 5,681,874 teaches a tire tread that is composed of three basic elastomers, namely, medium cis 1,4-polybutadiene rubber, isoprene/butadiene copolymer and natural cis 1,4-polyisoprene rubber and which is reinforced with either carbon black or a combination of carbon black and silica reinforcing fillers. The describe art is non-analogous in that an introduced roughness is employed which does not utilize the benefit of the tread groove surface area.

U.S. Pat. No. 5,967,211 teaches a tire with a rubber tread reinforced with silica and containing one or more additives designed to aid ice traction for the tread. Such additive is selected from at least one of (i) at least one organic fiber having hydroxyl groups on the surface thereof selected from cellulose fibers and wood fibers, and (ii) small, hollow, spherical ceramic particles having silanol groups on the surface thereof and containing silica as predominant particulate reinforcement and other traditional rubber compound ingredients. In particular, a coupler is used to couple the silica as well as the said additive(s) to the elastomer(s) in the tire tread composition. The describe art is non-analogous in that it fails to recognize the use of tread groove surface area.

U.S. Pat. No. 6,228,908 teaches the use of diene polymers or copolymers having improved balance between raw polymer viscosity and mixed compound viscosity, useful in tire tread compositions having highly balanced wet traction, rolling resistance, and traction in ice and snow. The improvement is directed at the tire composition and fails to recognize the benefit of tread groove surface area.

U.S. Pat. No. 6,303,688 teaches a rubber composition for tire tread, which can provide a tire having low decrease in abrasion resistance and balanced performance of traction property, braking property and cornering property. The rubber composition for tire tread is obtained by mixing at least one rubber component selected from the group consisting of a natural rubber, an isoprene rubber and a butadiene rubber, silica, a silane coupling agent and a powdered article containing cellulose material. Such a composition may have improved handling on regular surfaces, but there is no suggestion traction would be improved on wet, snow or ice surfaces.

US 20020037950 teaches a rubber composition for tire and a pneumatic tire in which the rubber composition used improves steering performance on snowy and icy roads. The rubber composition for tire contains paper relative the weight of a rubber component. The paper is newspaper waste. The invention utilizes the composition of the tire rather than taking advantage of the surface area of the tire grooves.

US 20050070681 teaches a composition comprising a polymer and methods of using the composition to increase the traction of an article of manufacture on an icy surface. The polymer can be a silicate polymer, a plancheite-derived polymer, a pinacol polymer, an indanol polymer, a phenol polymer, or an m-xylylene polymer. The composition is effective only for the portion of the tire in contact with the pavement and fails to utilize the surface area in the tread grooves.

Various products are on the market which are intended to help improve traction in the event of being stuck or in anticipation of bad weather. These products may be sprayed or brushed on the tire surface. Some are effective for up to 50 miles. Most are good for less than 10 miles, enough to get out of a situation.

The following are products on the market along with a brief description:

Tyre Grip—spray for use up to 50 miles. Active component is polydimethylsiloxane
Black Magic—spray foam for use up to two weeks. Active component is polydimethylsiloxane
Bare ground Tire Grip—spray for use up to 50 miles
Power Grip—improves traction up to 30%. Lasts up to 6 kilometers. Requires repeated applications.

### SUMMARY OF THE INVENTION

The present invention is a coating composition and method for inhibiting snow and/or ice buildup on a surface and for increasing traction to a snow-or-ice covered surface. The composition comprises a mixture of an oligomeric silicone with a polymeric binder, carried in a solvent. Preferably, the ratio of binder to silicone is in the range of 4:6 to 9:1, dissolved in 5% to 50% solvent.

The composition can be applied to any surface for which snow and ice buildup should be inhibited, such as tires, including deep within the tread configuration, shoes, boots, wheel wells on vehicles, roofs, gutters, walkways, outside rubber mats, solar panels, power and telephone lines, cables and the like. The result will last many miles and months on tires, and for months or years for other applications. The present invention satisfies the requirements of durability whereas other solutions to the problems of ice and snow buildup and loss of traction on ice and snow have been only short-term fixes and not a long-term solution.

### DESCRIPTION OF THE PREFERRED EMBODIMENTS

### Introduction

In the preferred embodiments, the binders used are preferably solid at room temperature. The silicones are preferably waxy to solid at room temperature. Blends of two or more polymers and/or two or more silicone compounds may be used advantageously depending upon, the specific application. The delivery or carrier system is a blend of two or more solvents which fully dissolve the polymers and silicone compounds, are rapid drying, compatible with and capable of wetting all surfaces to which the coatings may be applied. For certain surfaces, surfactants may be optionally, but advantageously employed.

Depending upon the intended application, the binder polymer(s) may be present from about 40% to about 90% solids (w/w). The silicone compounds may be present from about 10% to about 60% solids (w/w). Depending on the application, the composition as manufactured and applied comprises about 50-95% solids, with the balance being the solvent system which will be removed in the drying process. In other words, the ratio of binder to silicone can be from about 4:6 to 9:1, dissolved in from 5-50% solvent by weight. The most preferred composition comprises binder polymer to silicone in a ratio of 3:1 to 5:1, dissolved in 5-20% solvent by weight. All molecular weights as used herein are weight average molecular weights expressed as grams per mole, unless otherwise specified. The term polymer, as used herein, includes materials whether made by polymerization of one type of monomer or two or more types of monomers (i.e. copolymer, terpolymer, etc.).

### Binder Resin or Polymer

As noted above, the binders used are preferably solid at room temperature. The proper selection of a binding polymer is primarily dependent on the substrate to which the composition is applied. There must be chemical compatibility. Secondly, the shear modulus (Young's modulus) of the coating composition is preferred to be greater than that of the substrate to which it is applied. For example, rubber used in tires has a shear strength on average of 0.0006 GPa (shear measured in Pascals as the SI). Therefore, an effective coating for a rubber tire will have a shear modulus of ≥0.0006 GPa. Placing a coating on a nylon surface would require a modulus of 4.1 GPa, polyethylene would require 0.117 GPa, and so forth.

The composition preferably has a yield strength consistent with the substrate to which the composition is applied. If the adhesion is proper, a point of weakness is the ability of the applied coating to withstand tensile forces perpendicular to the direction the coating was applied. The tensile strength is the point at which the applied coating would be permanently distorted. A better measurement would be yield. Rubber have a yield strength of about 12 MPa whereas the tensile strength is 16 MPa. On a polyester surface the yield strength should be 55 MPa and polyethylene would be about 20 MPa. The coating composition should therefore have similar physical properties.

The preferred binder polymers are selected from the general classes of polyester, polyether, polyvinyl acetate, polyvinyl acetal, butylene terephthalate, epoxy vinyl esters, polyvinyl chloride, chlorinated polyvinyl chloride, fluoropolymers, polyisobutylene, polystyrene, vinyl acetal copolymers, vinyl ester copolymers, vinyl acetate copolymers, and the like.

More preferred polymers include but are not restricted to polyurethanes, bisphenol A epoxies, bisphenol A isophthalate, bisphenol A terephthalate, hydrophobically modified cellulose, polyacrylonitrile, polybutadiene, polyaramids, and the like.

Most preferred polymers included but are not restricted to nylon 6, nylon 66, nylon 610, polyurethane, polyacrylate, polymethacrylate, and other analogous co-, ter-, etc. polymers, aliphatic hydrocarbon resins (C5), aromatic hydrocarbon resins (C9), methacrylonitrile butadiene styrene, UV-curable resins, photopolymerizable polymers and the like.

The selection of the appropriate binding polymer is more determined by what surface is being coated. Once this is established the proper selection can be made by knowing the parameters stated above for shear and yield strength. The same polymer system used to coat a tire will be different than that used to coat the bottom of a boot, snowshoe or ski. All of these would be different from the system used to coat a vehicle wheel well, or roof shingles or cement walkway. Examples provided below will show the differentiation used in polymer selection.

### Silicone Oligomer/Polymer

The silicones are preferably waxy to solid at room temperature. In general, there are two types of silicone compounds, silanes and siloxanes. It is seen that silanes, which are liquid at room temperature, are too volatile, too low in viscosity and too hydrophilic to be of significant value in the present invention. Therefore, the preferred components are generally siloxanes. The preferred siloxane compound(s) would have a viscosity of greater than about 200 cps. More preferred would be greater than about 400 cps, and most preferred would be greater than about 1000 cps (this equates to about preferred being 230 cS), more preferred about 460 cS and most preferred being 1150 cS, wherein cps is centipoise and cS is centistokes.

The preferred silicone material would have a vapor pressure of <0.5 mm Hg. A key element to utility for any silicone candidate is the inability to evaporate quickly. Although the intended use is for cold weather applications, which retards evaporation, a preferred candidate is one that will not evaporate at ambient conditions. Examples of preferred siloxane compounds are octamethyltetracyclosiloxane, octamethyltrisiloxane, alkylmethylsiloxane, silicone alkylmethyl glycol, phenylmethylmethicone, trimethylstearyloxysiloxane, and the like.

More preferred compounds are decamethyl tetrasiloxane, alkylmethylsiloxane with methicone, amino alkoxydimethylsiloxane, phenylmethyl polysiloxane, hexamethyldisiloxane, dimethylmethylphenyl silicone, and the like.

Most preferred examples are but not limited to trimethylated silica, trimethylphenyl silsesquiloxane, polypropylsilsesquioxane, 3-aminomethyldiphenylsiloxane with phenyl silsesquioxane, cyclopentylsiloxane with dimethicone crosspolymer, cetyldiglyceryl tri(trimethylsiloxy) silylethyl dimethicone, 3-octylheptamethyl trisiloxane, hexafunctional silicone resin, dimethyldiphenylmethylphenylsilicon, phenylpropyl silsesquioxone, lauryl PEG 10 tris(trimethyl siloxy) silylethyl dimethicone, and the like. It is recognized that myriad silicone compounds exist and will be created.

Examples of likely non-suitable compounds would be low molecular weight siloxanes such as polydimethylsiloxane (any molecular weight), dimethyl siloxane with hydroxyl termination, ethoxylated dimethyl siloxane, dimethyl phenyl siloxane with terminal methoxy terminal groups, PEG 8 trisiloxane, potassium methyl siloxanate and the like. The most common siloxane compounds are dimethylsiloxanes, and cycloalkylsiloxanes (C5-C7). These materials are generally not suitable for use in the present invention. They are too volatile; the viscosities are too low, and they lack sufficient hydrophobicity to be effective.

It is recognized that depending upon the application that one or more silicone compounds may be advantageously blended to achieve specific results. No one silicone compound can solely suit all purposes. Tires will demand different coating characteristics than a cement sidewalk versus shingles for a roof application. One skilled in the art would recognize the required starting material to use based upon the required application.

### Solvent/Solubilizing System

The polymers and silicones heretofore described are soluble in myriad solvents. However, they are hydrophobic compounds, making the use of lipophilic solvents most preferable. The proper selection of a solvent system is dependent upon the substrate, the binder(s), silicone polymer(s) and any other addenda such as surfactants, adhesion promotors, dyes, pigments and the like. Generally, there are four classes of solvents. Hydrocarbon such as mineral spirits, benzene, xylene, hexane and dozens of other examples. Oxyhydrocarbons such as ethers, glycol ethers, aldehydes, esters, butyrolactone, and the like. Halogenated hydrocarbons such as chloromethane, chloroethane, fluoroaliphatics and the like. There are others based on nitrogen, sulfur and other elements such as dimethylformamide, dimethyl sulfoxide, N-methyl pyrrolidone and the like. One skilled in the art would recognize the proper solvent depending upon the end application, the surface, criticality of drying, compatibility of the solutes and so on. Certain plastic surfaces require surface tensions of <20 dynes.

Cosolvents are preferable. One should be a high vapor pressure solvent (HVPS) having a vapor pressure of over 10 mm Hg, which facilitates application and evaporates quickly, e.g. tetrahydrofuran (THF). The other should be a low vapor pressure solvent (LVPS) such as ethylene glycol monobutylether, which will better solubilize the binder. Additional Ingredients

Other addenda may be optionally and advantageously added to achieve specific results. For surfaces that are difficult to wet, surfactants at low levels may be employed to reduce surface tension for more effective coverage and surface penetration Tires can be effectively coated with solutions having surface tensions of about 35-40 dynes/cm². Certain plastic surfaces require surface tensions of <20 dynes/cm².

To insure the best adhesion of the coating applied to the intended substrate, adhesion promoters and coupling agents may be advantageously utilized to insure maximum yield strength. Examples of useful adhesion promoters include but are not limited to chlorinated polyolefins, polysulfides, polyurethanes, polyacrylates, polythioethers and the like.

### Methods of Production and Application

To produce the product, one can either mix the binder and silicone first and then dissolve, or dissolve each into the solvent separately. The methods of application of the product include spray, aerosol spray, dipping, etc. The surfaces treated can include tires, roofs, eves, wires, power lines, cables, solar panels, sidewalks, driveways, (sweep off).

### EXAMPLES

### Example 1 (Power Lines and Cables)

It is known that in winter conditions, ice build-up on power lines, cables and other tower suspend wires results in power outages due to ice accumulations and excessive weight resulting in powerline failure due to collapse. To assess the utility of the present claimed invention, a 6-foot section of 2″ tubing made of schedule 40 PVC piping was used to represent the conduit used for power lines for electrical and phone transmission. Half of the tube was coated with a composition comprising 6.0 grams of polyvinyl acetate (88% acetate, 12% hydroxyl) (binder), 5 grams of dimethyldiphenylmethylphenylsilicon (silicone) dissolved in a co-solvent of 50 grams of tetrahydrofuran (THF) [high vapor pressure solvent-over 10 mm Hg-evaporates quickly-facilitates application and evaporates quickly] and 39 grams of ethylene glycol monobutylether [lvps]. Upon drying the entire tube was place outdoors at −6° C. and sprayed with water. The process was repeated 6 times. After the last water application, the untreated side of the tube had icicles ranging from 3-7 cm. The treated side has no apparent build-up of ice or other residue. The utility of the hydrophobic ice resisting coating is readily apparent.

### Example 2 (Power Lines and Cables)

In like manner as described in Example 1, a 6-foot section of 12/3 Romex cable was used to represent outside power lines. Half of the tube was coated with a composition comprising 5.0 grams of polyvinyl butyral (binder), 5 grams of hexamethyldisiloxane (silicone) dissolved in a co-solvent of 50 grams of N-methyl pyrrolidone (lvps) and 39 grams of ethylene glycol monopropylether [hvps]. Upon drying the entire cable was placed outdoors at −6° C. and sprayed with water. The process was repeated 6 times. After the last water application, the untreated side of the tube had icicles ranging from 2-5 cm. The treated side has no apparent build-up of ice or other residue.

### Example 3 (Wound Wire Cables)

In like manner as described in Example 2, a 6-foot section of ¾ inch wound wire was used to represent outside support and connecting cables. Half of the cable was coated with a composition comprising 7.0 grams of an epoxy resin (Dow D.E.R. 642U-20) (binder), 5 grams of polypropylsilsesquioxane (silicone) dissolved in a co-solvent of 40 grams of ethylene glycol monomethyl ether, 40 grams of acetone [hvps], and 0.25 grams of 3M fluorocarbon surfactant 4432. Upon drying the entire wire was place outdoors at −6° C. and sprayed with water. The process was repeated 6 times. After the last water application, the untreated side of the tube had icicles ranging from 6-9 cm. The treated side had no apparent buildup or residue.

### Example 4 (Comparative Example)

In like manner as described in Example 3, a 6-foot section of 4 inch wire wound wire was coated with the same described composition except that the epoxy resin was eliminated, and nothing was used as the binder polymer. The coating was applied and dried. Upon drying the wire was placed outdoors at −6° C. and sprayed with water. The process was repeated 6 times. After the last water application, the untreated side of the tube has icicles ranging from 6-9 cm. The treated side had icicles ranging from 6 to 8 cm. It is suggested the silsesquioxane material was removed during the application of water. There is therefore no hydrophobicity residue and no durability. The binding polymer and siloxane must both be present for effective, long lasting performance.

### Example 5 (Comparative Example)

In like manner as described in Example 3, a 6-foot section of % inch wire wound wire was coated with the same described composition except that the polypropylsilsesquioxane is eliminated and nothing is used as the hydrophobic component. The coating was applied and dried. Upon drying the wire was place outdoors at −6° C. and sprayed with water. The process was repeated 6 times. After the last water application, the untreated side of the tube had icicles ranging from 6-9 cm. The treated side had icicles ranging from 6 to 7 cm. It is suggested the epoxy resin coating remained intact but lacked sufficient hydrophobicity to prevent ice buildup. The binding polymer and siloxane must both be present for effective, long lasting performance.

### Example 6 (Comparative Example)

A new set of Michelin tires were mounted on a Mercedes Benz C-300. No treatment was made to the tires. They were installed as received from the factory. On a road covered with 11 cm of snow at −8° C., the car is accelerated to 50 mph. There is considerable slippage (fish-tailing). The time from 0 to 50 mph was 10.1 seconds. At 50 mph, the car was brought to a stop as fast as possible. Again, there was considerable slippage and loss of traction. The total distance from the time brakes were applied until the car was stopped was 84 meters. It was observed that the entire time the testing was being performed, the treads were packed with snow such that the tread area was flush with the surface of the tire, thereby suggesting there was no means for effective traction.

### Example 7 (Tires)

In like manner as described in Example 6, a new set of Michelin tires were coated with a composition comprising 10 grams of C5 hydrocarbon resin (Binder), 9 grams of dimethyldiphenylmethylphenylsilicon (Silicone), 20 grams of odorless mineral spirits (lvps) and 7 grams of acetone (hvps). The coating was sprayed on the tires, dried and mounted on a Mercedes Benz C-300. On a road covered with 12 cm of snow at −9° C., the car is accelerated to 50 mph. There is no sliding nor slippage. The time from 0 to 50 mph is 4.2 seconds. At 50 mph, the car is brought to a stop as fast as possible. Again, no slippage or sliding was detected. The total distance from the time brakes were applied until the car was stopped was 32 meters. It was observed that the entire time the testing was being performed, no trace of snow and/or ice was detected in the treads of any of the four tires. This result suggests the hydrophobicity imparted by the silicon component prevented snow from packing the tread and therefore facilitated improved traction.

### Example 8 (Tires)

The same vehicle described in Example 7 was driven throughout the winter under snowy, icy and dry conditions. Periodically, the same acceleration and braking tests were performed. The intent was to determine the point where the coating was no longer effective. The tests were performed over two winters. There data were recorded and are given below:

| MILES FROM | ACCELERATION | BRAKING |
|---|---|---|
| APPLICATION | (sec) | (meters) |
| 1072 | 3.9 | 30 |
| 3223 | 4.1 | 32 |
| 5468 | 4.3 | 33 |
| 7807 | 4.5 | 35 |
| 8865 | 8.1 | 73 |

It can be seen from the data that the coating remained effective for about 8000 miles before effectiveness was lost. In contrast to known sprays on the market which last 50 miles or less, this represents a significant improvement. The visual key element is the prevention of snow and ice from building up in the treads. Up through 7807 miles, the treads were always clean. At 8865 miles it could be seen that the treads were becoming packed with ice and snow.

### Example 9 (Wet Surface Application)

A Chrysler 200 was used for the next test. The vehicle had 12, 813 miles on a set of Goodyear tires. The car was jacked off the ground. Without any preparation, a coating comprised of 12 grams of C9 hydrocarbon resin (most preferred binder), 10 grams of lauryl PEG 10 tris (trimethyl siloxy) silylethyl dimethicone (Most preferred silicone), 22 grams of odorless mineral spirits and 12 grams of ethyl acetate (hvps) was sprayed on the tires and dried. Prior to the application of the coating it was observed that the tires were damp. Under similar weather conditions as described in Example 7, the initial acceleration time was 5.5 seconds and the braking distance was 47 meters. Using the same test approach as detailed in Example 8, it was determined that the coating became ineffective after about 400 miles. The immediate suggestion from the data was that the coating is most preferably applied to a clean dry surface.

### Example 10 (Dry Tire Application Example)

In like manner as described in Example 9, the same vehicle with 12,344 miles had all four tires cleaned and completely dried. The same describe composition was used to spray coat the same, but clean and dry tires. The same tests were performed giving the data given below:

| MILES FROM | ACCELERATION | BRAKING |
|---|---|---|
| APPLICATION | (sec) | (meters) |
| 0 | 3.8 | 31 |
| 411 | 3.9 | 31 |
| 1667 | 4.1 | 31 |
| 3564 | 4.1 | 32 |
| 5892 | 4.2 | 33 |
| 8111 | 4.4 | 36 |
| 9382 | 4.6 | 37 |
| 10,588 | 8.9 | 81 |

From the foregoing it is clearly seen that a clean surface is preferable for maximum performance. A dry surface is also important so blooming of the applied coating does not occur. Further, the described composition provided slightly more than 9000 miles of safe driving.

### Example 11 (Wheel Well Application)

A Dodge Caravan with Yokohama tires having 15,889 miles of use was used to test the utility of applying a hydrophobic coating to the wheel well. A composition comprising 55 grams of methacrylonitrile butadiene styrene polymer (binder), 50 grams of trimethylated silica (silicone), 40 grams of butrolactone, 0.5 grams of Zonyl FNS fluorocarbon surfactant (wetting agent), 2.0 grams of Dynasylan MEMO adhesion promoter and 60 grams of toluene (hvps) was prepared. The front left and rear right wheel wells were cleaned thoroughly and dried. The above described composition was applied to the wells only. The front right and rear left wells remain untreated. The van was driven in various winter weather conditions over a period of two weeks. Most conditions were sub-freezing. The vehicle suffered from poor traction with long stops and considerable sliding. The purpose however of the present test was to assess the ability of the coated wheel wells to resist accumulation of ice, slush and snow. After two weeks and 524 miles of severe winter driving, it was observed that the untreated front right and rear left wells are packed solidly with hardened snow/ice. The tires rub against the buildup. With the use of a rubber mallet, the accumulation can be removed. In contrast, the front left and rear right wheel wells that were coated had no accumulation and fully free of any snow and ice. The difference was striking when visually contrasting the front and back wells on both sides.

### Example 12 (all Wheel Wells and all Tires)

The same van had the two untreated wheel wells treated with the same composition described in Example 1 after cleaning and drying. Additionally, all four tires were cleaned, dried and coated with the same composition used to treat the wheel wells. The mileage was 16,522 miles. Prior to the tire treatment, acceleration time to 50 mph was 12.6 seconds. The braking distance was 92 meters. After the van had all four tires and wells treated, winter driving was continued with improved traction and no buildup in the wells for the balance of the winter. The acceleration and stopping data are as follows:

| MILES FROM | ACCELERATION | BRAKING |
|---|---|---|
| APPLICATION | (sec) | (meters) |
| 0 | 4.8 | 40 |
| 922 | 5.1 | 42 |
| 2032 | 5.2 | 42 |
| 3713 | 5.3 | 45 |
| 6109 | 4.2 | 33 |
| 8111 | 4.4 | 34 |
| 9684 | 9.7 | 88 |

The before and after contrast again suggests the coatings are effective for up to about 8,000 miles before effectiveness is lost. For the balance of the test the wheel wells remained clean even into the next winter.

### Example 13 (Wiper Blades)

In winter driving a particularly common occurrence is the buildup of ice and snow on windshield wipers. This often requires breaking the ice free for minimal visibility, and when happening while driving poses a safety risk. A composition was prepared by mixing 2 grams of vinyl acetal/vinyl acetate copolymer (20:80)(binder), 2.5 grams of 3-octylheptamethyl trisiloxane (silicone), 4.0 grams of ethyl acetate (lvps) and 4.5 grams of acetone (hvps). The composition was applied to the wiper on the driver's side after being cleaned and dried. The other wiper remains untreated. On several occasions it was observed that snow and sleet would result in a buildup of ice on the untreated blade. This was particularly true when driving and evaporative cooling would cause the film to freeze. Over a period of six weeks buildup was observed, particularly in the morning on the passenger wiper blade. In no instance was any buildup ever observed on the driver side wiper blade.

### Example 14 (Driveway and Sidewalk)

A cement driveway and sidewalk were always prone to ice accumulation when snow would melt during the day and freeze again at night. Half of the driveway and sidewalk remained untreated. The other half was spray coated with a composition comprising 200 grams of polystyrene (binder), 250 grams of decamethyl tetrasiloxane (silicone), 800 grams of ethylene glycol monopropylether(lvps) and 700 grams of acetone (hvps). It was consistently noted that after several freeze/thaw cycles, the untreated cement surface had a sheet of ice accumulation which could not be shoveled or scraped off. The ice on the treated side was easily removed by chipping the ice and sweeping it away with a broom.

### CONCLUSION

Thus, these compositions can be applied to any surface for which snow and ice buildup should be inhibited, such as tires, including deep within the tread configuration, shoes, boots, wheel wells on vehicles, roofs, gutters, walkways, outside rubber mats, solar panels, power and telephone lines, cables and the like. The preferred embodiment coatings possess excellent adhesion properties, are durable for greater than 8,000 miles for tire applications or greater than two years for non-vehicle applications, possesses high tensile strength, high shear modulus and above all are extremely hydrophobic. The present invention satisfies the issue of durability whereas other solutions to the problems have been only quick fixes and not a long-term solution.

It will be understood that variations and modifications of the forgoing description of the preferred embodiments can be effected within the spirit and scope of the invention.

1. A coating composition for inhibiting snow and/or ice buildup on a surface and for increasing traction to a snow-or-ice covered surface comprising a mixture of at least one polymeric binder and at least one oligomeric silicone, carried in a solvent.

2. The coating composition of claim 1 in which the ratio of said binder to said silicone is in the range of 4:6 to 9:1, and the combination of binder and silicone is dissolved in 5% to 50% solvent by weight.

3. The coating composition of claim 1 in which the binder polymer to silicone ratio range is 3:1 to 5:1, and the combination of binder and silicone is dissolved in 5-20% solvent by weight.

4. The coating composition of claim 2 in which said polymeric binders are preferably solid at room temperature and said silicones are preferably waxy to solid at room temperature.

5. The coating composition of claim 4 in which said silicone is one that will not evaporate under ambient conditions.

6. The coating composition of claim 5 in which said silicone has a vapor pressure of <0.5 mm Hg.

7. The coating composition of claim 6 in which said silicone is a siloxane.

8. The coating composition of claim 7 in which said siloxane has a viscosity of greater than about 200 cps.

9. The coating composition of claim 7 in which said siloxane has a viscosity of greater than about 400 cps.

10. The coating composition of claim 7 in which said siloxane has a viscosity of greater than about 1000 cps.

11. The coating composition of claim 5 in which said solvent is a blend of two or more solvents which fully dissolve the polymers and silicone compounds, are rapid drying, compatible with and capable of wetting all surfaces to which the coatings may be applied.

12. The coating composition of claim 11 in which said solvent also incorporates at least one surfactant.

13. The coating composition of claim 5 in said coating has a shear modulus of ≥0.0006 GPa.8.

14. The coating composition of claim 13 in which said coating has a yield strength of at least 12 MPa and a tensile strength of at least 16 MPa.

15. The coating composition of claim 5 in which said binder polymers are selected from the general classes of polyester, polyether, polyvinyl acetate, polyvinyl acetal, butylene terephthalate, epoxy vinyl esters, polyvinyl chloride, chlorinated polyvinyl chloride, fluoropolymers, polyisobutylene, polystyrene, vinyl acetal copolymers, vinyl ester copolymers, vinyl acetate copolymers, polyurethanes, bisphenol A epoxies, bisphenol A isophthalate, bisphenol A terephthalate, hydrophobically modified cellulose, polyacrylonitrile, polybutadiene, polyaramides, nylon 6, nylon 66, nylon 610, polyacrylate, polymethacrylate, and analogous co-, ter-, etc. polymers, aliphatic hydrocarbon resins (C5), aromatic hydrocarbon resins (C9), methacrylonitrile butadiene styrene, UV-curable resins, and photopolymerizable polymers.

16. The coating composition of claim 5 in which said silicone is selected from octamethyltetracyclosiloxane, octamethyltrisiloxane, alkylmethylsiloxane, silicone alkylmethyl glycol, phenylmethylmethicone, trimethylstearyloxysiloxane, decamethyl tetrasiloxane, alkylmethylsiloxane with methicone, amino alkoxydimethylsiloxane, phenylmethyl polysiloxane, and hexamethyldisiloxane, and dimethylmethylphenyl silicone.

17. The coating composition of claim 5 in which said silicone is selected from trimethylated silica, trimethylphenyl silsesquiloxane, polypropylsilsesquioxane, 3-aminomethyl-diphenylsiloxane with phenyl silsesquioxane, cyclopentylsiloxane with dimethicone crosspolymer, cetyldiglyceryl tri(trimethylsiloxy) silylethyl dimethicone, 3-octylheptamethyl trisiloxane, hexafunctional silicone resin, dimethyldiphenylmethylphenylsilicon, phenylpropyl silsesquioxone, lauryl PEG 10 tris(trimethyl siloxy) silylethyl dimethicone, and the like. It is recognized that depending upon the application that one or more silicone compounds may be advantageously blended to achieve specific results. No one silicone compound can solely suit all purposes. Tires will demand different coating characteristics than a cement sidewalk versus shingles for a roof application. One skilled in the art would recognize the required starting material to use based upon the required application.

18. A method for inhibiting snow and/or ice buildup on a surface and for increasing traction to a snow-or-ice covered surface comprising applying to the surface the coating composition of claim 1.

19. The method of claim 18 in which said coating is formulated to have a yield strength consistent with the yield strength of the substrate to which the composition is applied of said coating.

20. The method of claim 19 in which for rubber surfaces said coating is formulated to have a yield strength of about 12 MPa and a tensile strength is 16 MPa.

21. The method of claim 19 in which for a polyester surface said coating is formulated to have a yield strength of about 55 MPa and for a polyethylene surface is formulated to have a yield strength of about 20 MPa.
